(19) United States
(12) Patent Application Publication
(10) Pub. No.: US 2014/0369332 A1
(43) Pub. Date: Dec. 18, 2014

(54) WIRELESS LOCAL AREA NETWORK ROUTER AND COMMUNICATIONS METHOD THEREOF

(71) Applicant: Samsung Electro-Mechanics Co., Ltd.,, Suwon (KR)

(72) Inventors: Dae Yeol Seo, Suwon (KR); Se Jong Kim, Suwon (KR); Young Seo Park, Suwon (KR)

(73) Assignee: Samsung Electro-Mechanics Co. Ltd., Suwon (KR)

(21) Appl. No.: 14/300,839

(22) Filed: Jun. 10, 2014

(30) Foreign Application Priority Data
Jun. 14, 2013 (KR) 10-2013-0068626

(51) Int. Cl. H04W 84/12

(52) U.S. Cl. CPC H04W 84/12
USPC 370/338

(57) ABSTRACT

A wireless local area network (WLAN) router may include: a controlling unit selecting a temporary relay terminal among good communications terminals and performing controlling to request that the selected temporary relay terminal perform a WLAN temporary relay, in the case in which support target terminals outside of a WLAN good communications area are present; a WLAN communications unit performing WLAN communications with communications-enabled terminals depending on the controlling of the controlling unit to collect information required for selecting the temporary relay terminal from the communications-enabled terminals and provide the collected information to the controlling unit; and a local area communications unit requesting that the temporal relay terminal perform the WLAN temporal relay of the support target terminals depending on the controlling of the controlling unit.

### CROSS-REFERENCE TO RELATED APPLICATION

This application claims the benefit of Korean Patent Application No. 10-2013-0068626 filed on Jun. 14, 2013, with the Korean Intellectual Property Office, the disclosure of which is incorporated herein by reference.

### BACKGROUND

The present disclosure relates to a wireless local area network (WLAN) router capable of expanding a WLAN communications area, and a communications method thereof.

Recently, in accordance with the continuing development of communications technology, various functions have been added to communications terminals. Particularly, communications terminals compatible with a variety of communications schemes have been released onto the market.

For example, a mobile communications terminal has a function of access to communications via a mobile communications network as a basic function thereof. However, recently, the function of an access to communications via a Wireless Local Area Network (WLAN), such as a Wireless Fidelity (Wi-Fi) WLAN has been added to mobile communications terminals.

In the case in which the mobile communications terminal performs access to communications via a WLAN instead of via mobile communications through a base station as described above, a WLAN router providing WLAN access service should be provided in the wireless communications terminal.

Such a WLAN router performs WLAN communications with various communications terminals in a state in which it accesses a wired network to serve to transfer a signal transmitted by a corresponding communications terminal to the wired network and transfer a signal received from the wired network to the corresponding communications terminal.

However, such a WLAN router may have a problem that communications may not be smoothly performed, depending on a distance between the communications terminal and the WLAN router due to movement of the communications terminal or due to an obstacle existing between the WLAN router and the communications terminal.

For example, in the case in which such a WLAN router is used in a living room, a connection between the WLAN router and the communications terminal may be made smoothly in the living room. However, in the case in which a user moves to a bathroom or a room while carrying the communications terminal, communications may be disconnected or a network may be unstable due to an obstacle between the WLAN router and the communications terminals or through limitations in a communications distance. In this case, there may be a problem in that Internet access may be disconnected or blocked.

The following Related Art Document (Patent Document 1), relating to a system and a method of expanding a cell coverage of a base, does not disclose a feature of automatically requesting that a communications terminal in a WLAN relay-enabled area to perform a WLAN temporary relay with respect to a communications terminal outside of the WLAN communications-enabled area.

### RELATED ART DOCUMENT

(Patent Document 1) Korean Patent Laid-Open Publication No. 2004-0055493

### SUMMARY

An aspect of the present disclosure may provide a Wireless Local Area Network (WLAN) router capable of expanding a WLAN communications area by automatically requesting that a communications terminal in a WLAN communications-enabled area perform a WLAN temporary relay with respect to a communications terminal outside of the WLAN communications-enabled area, and a communications method thereof.

According to an aspect of the present disclosure, a WLAN router may include: a controlling unit selecting a temporary relay terminal among good communications terminals and performing controlling to request that the selected temporary relay terminal perform a WLAN temporary relay, in the case in which support target terminals outside of a WLAN good communications area are present; a WLAN communications unit performing WLAN communications with communications-enabled terminals depending on the controlling of the controlling unit to collect information required for selecting the temporary relay terminal from the communications-enabled terminals and provide the collected information to the controlling unit; and a local area communications unit requesting that the temporal relay terminal perform the WLAN temporal relay of the support target terminals depending on the controlling of the controlling unit.

The controlling unit may perform controlling to request that the temporal relay terminal selected from among relay candidate terminals depending on a preset selection reference perform the WLAN temporal relay, for the purpose of the support target terminals, the support target terminals having first signal strengths lower than a first reference strength that is preset to thereby be in a poor communications state, the relay candidate terminals having second signal strengths higher than a second reference strength that is preset to thereby be in a good communications state, the first signal strengths corresponding to signal strengths between the WLAN router and the communications-enabled terminals capable of performing the WLAN communications, and the second signal strengths corresponding to signal strengths between the support target terminals and the communications-enabled terminals.

The controlling unit may determine relay priorities as the selection reference depending on a preset priority determining scheme and select a communications-enabled terminal having the highest priority as the temporary relay terminal.

The controlling unit may calculate the relay priority based on at least one of the first and second signal strengths.

The controlling unit may calculate the relay priority by calculating a signal strength change amount per second of the first signal strength, multiplying the first signal strength, the second signal strength, and the signal strength change amount per second by preset weights, respectively, and then adding them together.

The controlling unit may include: a first signal strength collecting unit collecting the first signal strengths between the communications-enabled terminals and the WLAN router; a support target determining unit determining the support target terminals having the first signal strengths lower than the first reference strength; a second signal strength collecting unit collecting the second signal strengths between the support target terminals and the communications-enabled terminals; a relay terminal selecting unit determining that the communications-enabled terminals having the second signal strengths higher than the second reference strength are the relay candidate terminals and selecting the temporal relay terminal among the relay candidate terminals depending on the preset selection reference; and a relay requesting unit requesting that the temporary relay terminal perform the WLAN temporal relay.

The relay terminal selecting unit may determine relay priorities as the selection reference depending on a preset priority determining scheme and select a communications-enabled terminal having the highest priority as the temporary relay terminal.

The relay terminal selecting unit may calculate the relay priority based on at least one of the first and second signal strengths.

The relay terminal selecting unit may calculate the relay priority by calculating a signal strength change amount per second of the first signal strength, multiplying the first signal strength, the second signal strength, and the signal strength change amount per second by preset weights, respectively, and then adding them together.

According to another aspect of the present disclosure, a WLAN router may include: a controlling unit performing controlling to request a temporal relay terminal selected from among relay candidate terminals depending on a preset selection reference to perform a WLAN temporal relay, for the purpose of support target terminals, the support target terminals having first signal strengths lower than a first reference strength that is preset, the relay candidate terminals having second signal strengths higher than a second reference strength that is preset, the first signal strengths corresponding to signal strengths between the WLAN router and communications-enabled terminals capable of performing WLAN communications, and the second signal strengths corresponding to signal strengths between the support target terminals and the communications-enabled terminals; a WLAN communications unit performing the WLAN communications with the communications-enabled terminals depending on the controlling of the controlling unit to collect the first signal strengths and information required for selecting the temporary relay terminal from the communications-enabled terminals and provide the collected first signal strengths and information to the controlling unit; and a local area communications unit requesting that the temporal relay terminal perform the WLAN temporal relay of the support target terminals depending on the controlling of the controlling unit, wherein the controlling unit determines relay priorities as the selection reference based on the first and second signal strengths and selects a communications-enabled terminal having the highest priority as the temporary relay terminal.

The controlling unit may calculate the relay priority by multiplying the first signal strength and the second signal strength by preset weights, respectively, and then adding them together.

The controlling unit may calculate the relay priority by calculating a signal strength change amount per second of the first signal strength, multiplying the first signal strength, the second signal strength, and the signal strength change amount per second by preset weights, respectively, and then adding them together.

According to another aspect of the present disclosure, a communications method of a WLAN router may include: determining support target terminals having first signal strengths lower than a first reference strength that is preset, the first signal strengths corresponding to signal strengths between the WLAN router and communications-enabled terminals capable of performing WLAN communications; determining that communications-enabled terminals having second signal strengths higher than a second reference strength that is preset are relay candidate terminals and selecting a temporal relay terminal among the relay candidate terminals depending on a preset selection reference, the second signal strengths corresponding to signal strengths between the support target terminals and the communications-enabled terminals; and requesting that the selected temporal relay terminal perform a WLAN temporal relay.

The determining of the support target terminals may include: collecting the first signal strengths between the communications-enabled terminals and the WLAN router; and determining the support target terminals having the first signal strengths lower than the first reference strength that is preset.

The determining of the support target terminals may include: collecting the first signal strengths between the communications-enabled terminals and the WLAN router and measuring signal strength change values per second of the first signal strengths; and determining the support target terminals depending on the first signal strengths and the signal strength change values.

The determining of the support target terminals may include: collecting the first signal strengths between the communications-enabled terminals and the WLAN router and measuring signal strength change values per second of the first signal strengths; determining monitoring target terminals depending on the first signal strengths and the signal strength change values; and determining that communications-enabled terminals having the first signal strengths lower than the first reference strength among the monitoring target terminals are the support target terminals.

The selecting of the temporal relay terminal may include: collecting the second signal strengths between the support target terminals and the communications-enabled terminals; determining that the communications-enabled terminals having the second signal strengths higher than the second reference strength are the relay candidate terminals; determining the relay priorities with respect to the relay candidate terminals depending on a preset priority determining scheme; and selecting a relay candidate terminal having the highest priority as the temporal relay terminal.

The requesting of the selected temporal relay terminal to perform the WLAN temporal relay may include requesting that the temporal relay terminal perform the WLAN temporal relay and providing information on the temporal relay terminal to the support target terminals.

The selecting of the temporal relay terminal may include calculating the relay priority based on at least one of the first and second signal strengths.

The selecting of the temporal relay terminal may include calculating the relay priority by multiplying the first signal strength and the second signal strength by preset weights, respectively, and then adding them together.

The selecting of the temporal relay terminal may include calculating the relay priority by calculating a signal strength change amount per second of the first signal strength, multiplying the first signal strength, the second signal strength, and the signal strength change amount per second by preset weights, respectively, and then adding them together.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a block diagram of a wireless local area network (WLAN) router according to an exemplary embodiment of the present disclosure;

FIG. 2 is a block diagram of a controlling unit according to an exemplary embodiment of the present disclosure;

FIG. 3 is a diagram illustrating a communications-enabled area and a good communications area between the WLAN router and terminals according to an exemplary embodiment of the present disclosure;

FIG. 4 is a flow chart illustrating a communications method of a WLAN router according to an exemplary embodiment of the present disclosure;

FIG. 5 is a flow chart illustrating a first implementation of a process of determining support target terminals according to an exemplary embodiment of the present disclosure;

FIG. 6 is a flow chart illustrating a second implementation of a process of determining support target terminals according to an exemplary embodiment of the present disclosure;

FIG. 7 is a flow chart illustrating a process of selecting a temporary relay terminal according to an exemplary embodiment of the present disclosure; and

FIG. 8 is a flow chart illustrating a process of requesting that the temporal relay terminal perform a WLAN temporary relay according to an exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. Throughout the drawings, the same or like reference numerals will be used to designate the same or like elements.

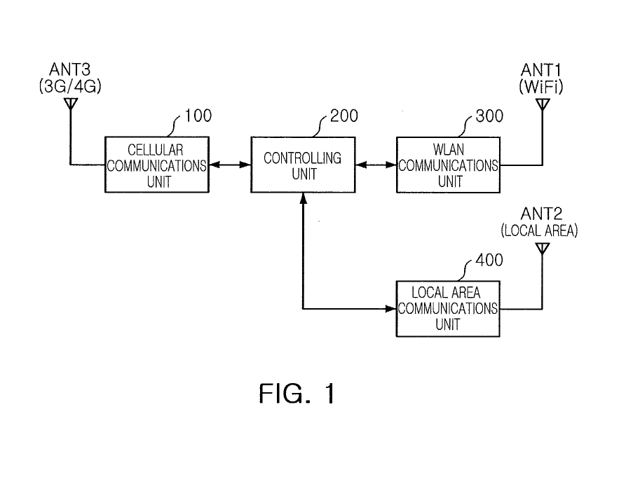

FIG. 1 is a block diagram of a wireless local area network (WLAN) router according to an exemplary embodiment of the present disclosure.

Referring to FIG. 1, the WLAN router according to an exemplary embodiment of the present disclosure may include a controlling unit 200, a WLAN communications unit 300, and a local area communications unit 400.

In addition, the WLAN router may further include a cellular communications unit 100. The cellular communications unit 100 may process cellular communications using a cellular telephone network such as the third generation (3G), the fourth generation (4G), or the like.

Here, a first antenna ANT1 for Wi-Fi may be connected to the WLAN communications unit 300, a second antenna ANT2 for local area communications may be connected to the local area communications unit 400, and a third antenna ANTS for cellular such as the 3G, the 4G, or the like, may be connected to the cellular communications unit 100.

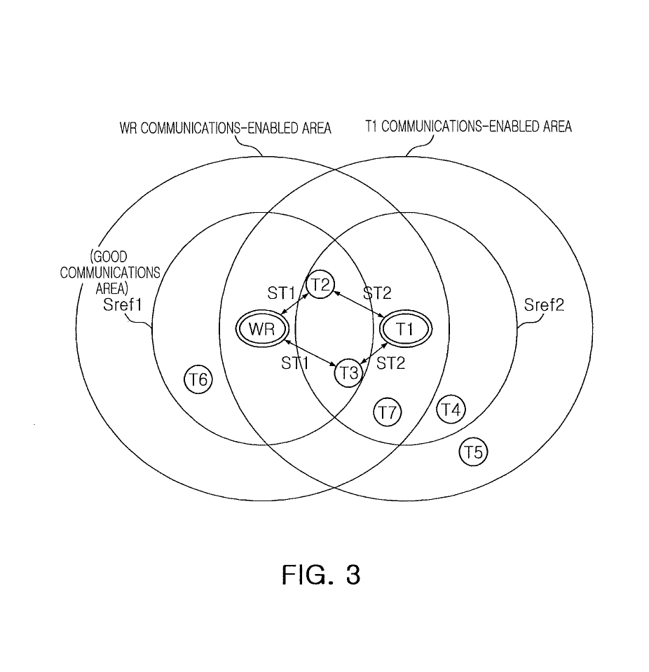

The controlling unit 200 may select a temporary relay terminal among good communications terminals and perform controlling to request that the selected temporary relay terminal perform a WLAN temporary relay request, in the case in which support target terminals outside of a WLAN good communications area (WR communications-enabled area of FIG. 3) are present.

As one implementation, the controlling unit 200 may perform controlling to request that the temporal relay terminal selected from among relay candidate terminals depending on a preset selection reference perform the WLAN temporal relay, for the purpose of the support target terminals, wherein the support target terminals have first signal strengths ST1 lower than a first reference strength Sref1 that is preset to thereby be in a poor communications state, the relay candidate terminals have second signal strengths ST2 higher than a second reference strength Sref2 that is preset to thereby be in a good communications state, the first signal strengths ST1 correspond to signal strengths between the WLAN router and communications-enabled terminals capable of performing WLAN communications, and the second signal strengths ST correspond to signal strengths between the support target terminals and the communications-enabled terminals.

Here, the controlling unit 200 may determine relay priorities as the selection reference depending on a preset priority determining scheme and select a communications-enabled terminal having the highest priority as the temporary relay terminal.

The WLAN communications unit 300 may perform the WLAN communications with the communications-enabled terminals depending on the controlling of the controlling unit 200 to collect information required for selecting the temporary relay terminal from the communications-enabled terminals and provide the collected information to the controlling unit 200.

For example, the WLAN communications unit 300 may request that the communications-enabled terminals positioned in the vicinity of the WLAN router transmit the first signal strengths ST1 through WLAN communications, thereby receiving the first signal strengths ST1, wherein the first signal strengths ST1 correspond to signal strengths between the WLAN router and the communications-enabled terminals.

Here, the WLAN communications may be one of IEEE 802.11, 802.11a, 802.11b, 802.11g, 802.11n, and IEEE 802.11ac.

The local area communications unit 400 may request that the temporal relay terminal perform the WLAN temporal relay of the support target terminals depending on the controlling of the controlling unit 200.

Here, a local area communications scheme may be one of a Bluetooth™ scheme, a Zigbee scheme, and a WLAN communications scheme. Here, in the case in which the WLAN communications scheme is used as the local area communications scheme, a frequency band (for example, 2.4 GHz) different from a frequency band (for example, 5 GHz) applied to the WLAN communications unit 300 may be set.

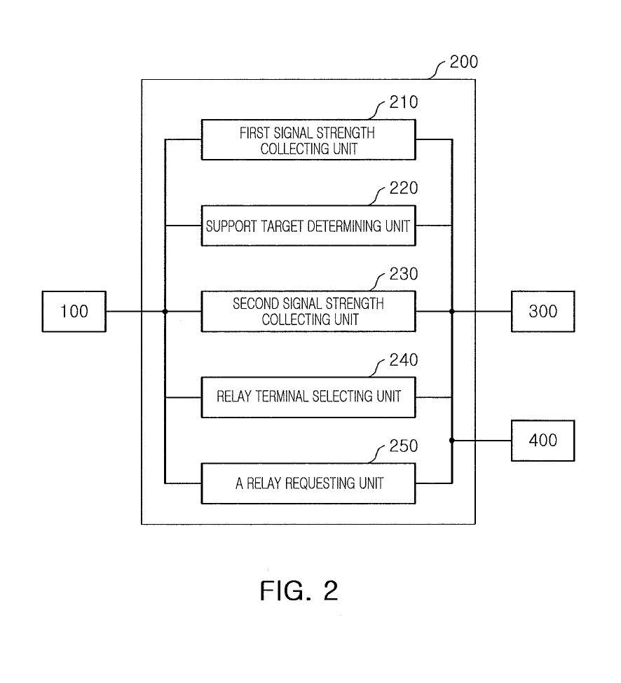

FIG. 2 is a block diagram of a controlling unit according to an exemplary embodiment of the present disclosure. Referring to FIGS. 1 and 2, the controlling unit 200 may include a first signal strength collecting unit 210, a support target determining unit 220, a second signal strength collecting unit 230, a relay terminal selecting unit 240, and a relay requesting unit 250.

The first signal strength collecting unit 210 may collect the first signal strengths ST1 between the communications-enabled terminals and the WLAN router.

That is, the first signal strength collecting unit 210 may request that the communications-enabled terminals positioned in the vicinity of the WLAN router transmit the first signal strengths ST1 through the WLAN communications, thereby receiving the first signal strengths ST1, wherein the first signal strengths ST1 correspond to signal strengths between the WLAN router and the communications-enabled terminals.

The support target determining unit 220 may determine the support target terminals having the first signal strengths ST1 lower than the first reference strength Sref1.

The second signal strength collecting unit 230 may collect the second signal strengths ST2 between the support target terminals and the communications-enabled terminals.

That is, the second signal strength collecting unit 230 may request that the communications-enabled terminals positioned in the vicinity of the WLAN router transmit the second signal strengths ST2 between the support target terminals and the communications-enabled terminals through the WLAN communications, thereby receiving the second signal strengths ST2.

The relay terminal selecting unit 240 may determine that the communications-enabled terminals having the second signal strengths ST2 higher than the second reference strength Sref2 are the relay candidate terminals and select the temporal relay terminal among the relay candidate terminals depending on the preset selection reference.

Here, the relay terminal selecting unit 240 may determine relay priorities as the selection reference depending on a preset priority determining scheme and select a communications-enabled terminal having the highest priority as the temporary relay terminal.

The relay requesting unit 250 may request that the temporary relay terminal perform the WLAN temporal relay.

As an example, the relay requesting unit 250 may request that the temporary relay terminal perform the WLAN temporal relay, and may provide information on the temporary relay terminal to the support target terminals. Therefore, the temporary relay terminal may perform the temporal relay for the support target terminals.

Next, the relay priority will be described.

The relay terminal selecting unit 240 of the controlling unit 200 may calculate the relay priority based on at least one of the first and second signal strengths ST1 and ST2.

For example, the relay terminal selecting unit 240 may calculate the relay priority based on the first signal strength ST1. Alternatively, the relay terminal selecting unit 240 may calculate the relay priority based on the second signal strength ST2. Alternatively, the relay terminal selecting unit 240 may calculate the relay priority based on the sum of the first and second signal strengths ST1 and ST2.

Describing an example that may be further implemented, the relay terminal selecting unit 240 may calculate the relay priority as represented by the following Mathematical Equation 1 based on the first and second signal strengths ST1 and ST2.

Relay Priority Value=a*ST1+b*ST2 [Mathematical Equation 1]

Here, a is a weight of the first signal strength ST1, and b is a weight of the second signal strength.

As another scheme, the relay terminal selecting unit 240 may calculate the relay priority by calculating a signal strength change amount ΔST per second of the first signal strength ST1, multiplying the first signal strength ST1, the second signal strength ST2, and the signal strength change amount ΔST per second by preset weights, respectively, and then adding them together.

Relay Priority Value=a*ST1+b*ST2+c*ΔST [Mathematical Equation 2]

Here, a is a weight of the first signal strength ST1, b is a weight of the second signal strength, and c is a weight of the signal strength change amount ΔST per second.

Mathematical Equations 1 and 2 as described above are only two implementations and the weights of each of Mathematical Equations 1 and 2 are only examples. Therefore, they may be variously changed depending on an application environment.

FIG. 3 is a diagram illustrating a communications-enabled area and a good communications area between the WLAN router and terminals according to an exemplary embodiment of the present disclosure.

Referring to FIGS. 1 through 3, in the case in which a WR communications-enabled area and a good communications area Sref1 are set based on the WLAN router WR, support target terminals having signal strengths lower than the first reference strength Sref1 may be T1 and T7.

Next, a temporal relay process for the support target terminals T1 will be described. In the case in which a T1 communications-enabled area and a good communications area Sref2 are set based on the support target terminal T1, relay candidate terminals T2, T3, and T7 included in the WR communications-enabled area and having signal strengths higher than the second reference strength Sref2 may be T2, T3, and T7.

As an example, in the case in which the first signal strength ST1, the second signal strength ST2, and the signal strength change amount ΔST per second of each of the relay candidate terminals T2, T3, and T7 correspond to values as shown in the following Table 1, relay priority values also correspond to values as shown in the following Table 1. However, it is assumed that a, b, and c in Mathematic Equation 2 are set to 0.5, 0.4, and 0.2, respectively.

TABLE 1

| Terminal | ST12 | ST2 | ΔST | Relay Priority Value |
|---|---|---|---|---|
| T2 | 80 | 60 | 10 | 0.5 * 80 + 0.4 * 60 + 0.2 * 10 = 66 |
| T3 | 70 | 80 | 10 | 0.5 * 70 + 0.4 * 80 + 0.2 * 10 = 69 |
| T7 | 50 | 50 | 10 | 0.5 * 50 + 0.4 * 50 + 0.2 * 10 = 47 |

Referring to Table 1, a terminal T3 having the highest relay priority value among the relay candidate terminals T2, T3, and T7 may be selected as the temporal relay terminal.

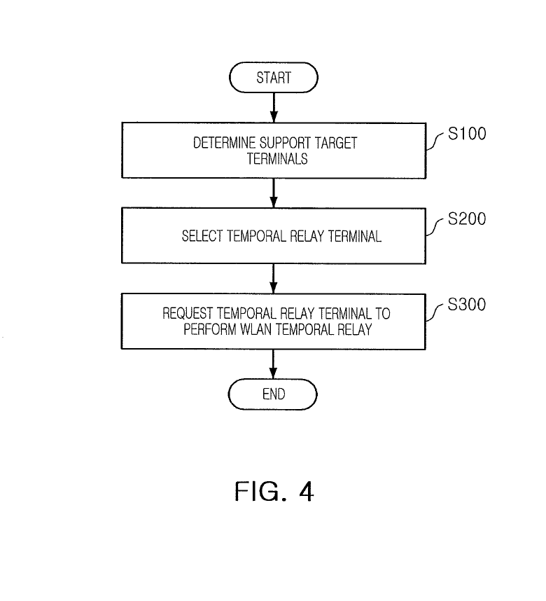

FIG. 4 is a flow chart illustrating a communications method of a WLAN router according to an exemplary embodiment of the present disclosure.

A communications method of a WLAN router according to an exemplary embodiment of the present disclosure will be described with reference to FIGS. 1 through 4.

Hereinafter, in describing a communications method of a WLAN router according to an exemplary embodiment of the present disclosure, a description for an operation described with reference to FIGS. 1 through 4 may be applied as it is. Therefore, in a description for a communications method of a WLAN router according to an exemplary embodiment of the present disclosure, an overlapped detailed description will be omitted.

Referring to FIGS. 1 to 4, a communications method of a WLAN router according to an exemplary embodiment of the present disclosure may include a process S100, a process S200, and a process S300.

In the process S100, the WLAN router may determine the support target terminals having the first signal strengths ST1 lower than the first reference strength Sref1 that is preset, wherein the first signal strengths ST1 corresponds to signal strengths between the WLAN router and the communications-enabled terminals capable of performing the WLAN communications.

Next, in the process S200, the WLAN router may determine that the communications-enabled terminals having the second signal strengths ST2 higher than the second reference strength Sref2 that is preset are the relay candidate terminals and select the temporal relay terminal among the relay candidate terminals depending on the preset selection reference, wherein the second signal strengths ST2 correspond to signal strengths between the support target terminals and the communications-enabled terminals.

Then, in the process S300, the WLAN router may request that the selected temporal relay terminal perform the WLAN temporal relay.

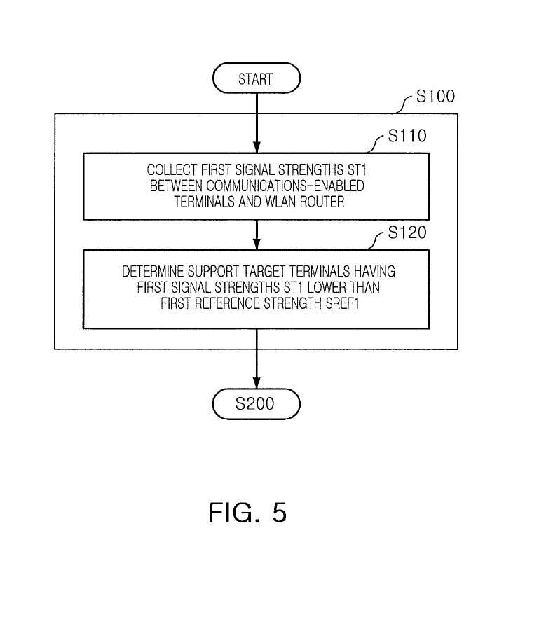

FIG. 5 is a flow chart illustrating a first implementation of a process of determining support target terminals according to an exemplary embodiment of the present disclosure.

Referring to FIGS. 1 through 5, in the process S100 of determining the support target terminals, the WLAN router may collect the first signal strengths ST1 between the communications-enabled terminals and the WLAN router (S110).

Next, the WLAN router may determine the support target terminals having the first signal strengths ST1 lower than the first reference strength Sref1 that is preset (S120).

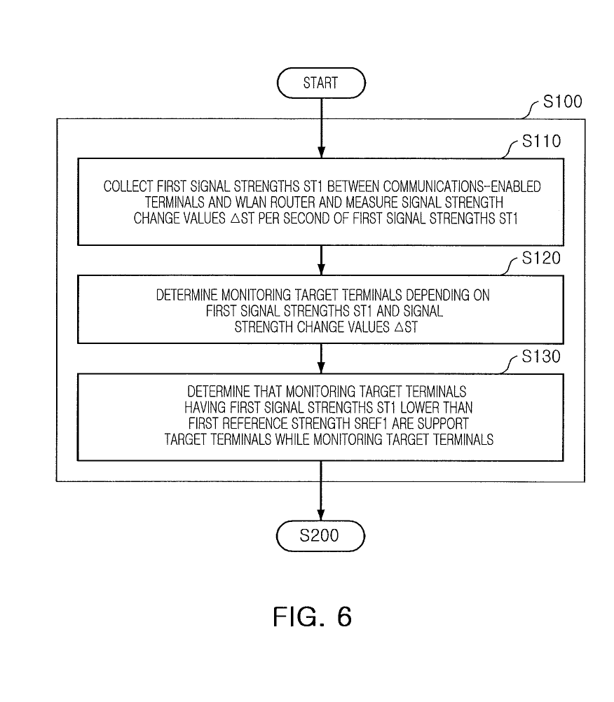

FIG. 6 is a flow chart illustrating a second implementation of a process of determining support target terminals according to an exemplary embodiment of the present disclosure.

A first implementation of the process S100 of determining the support target terminals will be described with reference to FIGS. 1 through 6. First, the WLAN router may collect the first signal strengths ST1 between the communications-enabled terminals and the WLAN router and measure the signal strength change values ΔST per second of the first signal strengths ST.

Next, the WLAN router may determine the support target terminals depending on the first signal strengths ST1 and the signal strength change values ΔST.

In addition, another implementation of the process S100 of determining the support target terminals will be described. First, the WLAN router may collect the first signal strengths ST1 between the communications-enabled terminals and the WLAN router and measure the signal strength change values ΔST per second of the first signal strengths ST1 (S110).

Next, the WLAN router may determine monitoring target terminals depending on the first signal strengths ST1 and the signal strength change values ΔST.

In addition, the WLAN router may determine that communications-enabled terminals having the first signal strengths ST1 lower than the first reference strength Sref1 among the monitoring target terminals are the support target terminals.

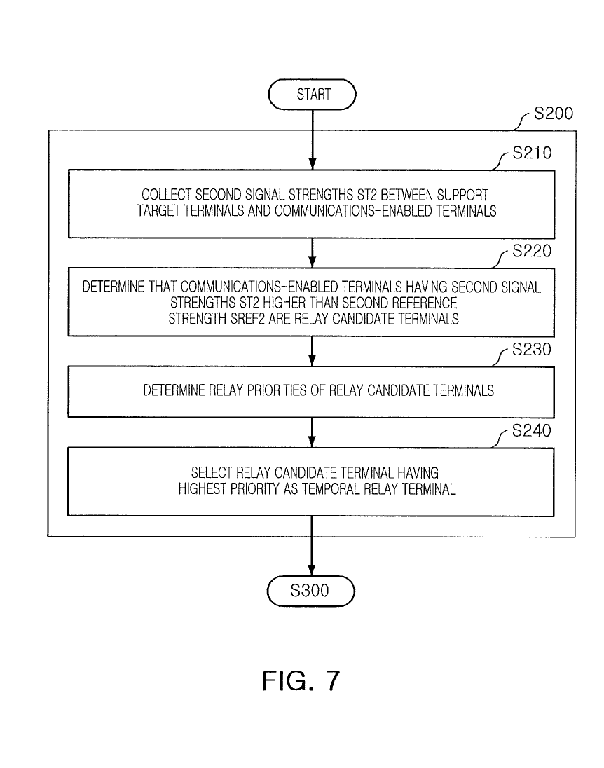

FIG. 7 is a flow chart illustrating a process of selecting a temporary relay terminal according to an exemplary embodiment of the present disclosure.

One implementation of the process S200 of selecting the temporal relay terminal will be described with reference to FIGS. 1 through 7. First, the WLAN router may collect the second signal strengths ST2 between the support target terminals and the communications-enabled terminals (S210).

Next, the WLAN router may determine that the communications-enabled terminals having the second signal strengths ST2 higher than the second reference strength Sref2 are the relay candidate terminals (S220).

Next, the WLAN router may determine the relay priorities with respect to the relay candidate terminals depending on the preset priority determining scheme (S230).

Then, the WLAN router may select the relay candidate terminal having the highest priority as the temporal relay terminal (S240).

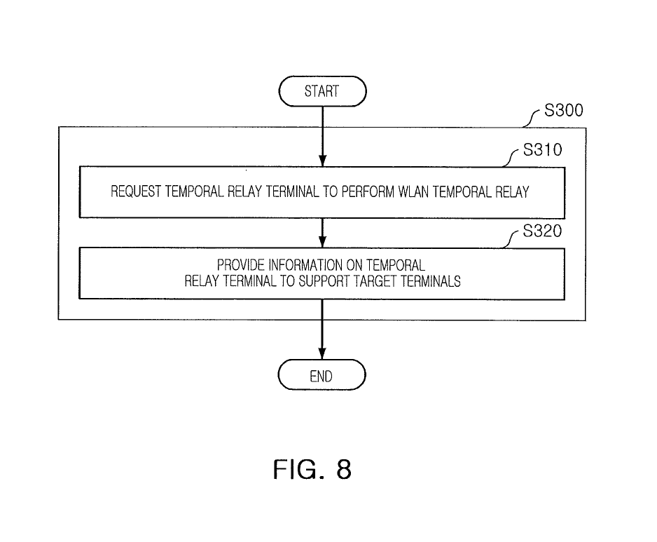

FIG. 8 is a flow chart illustrating a process of requesting that the temporal relay terminal perform a WLAN temporary relay according to an exemplary embodiment of the present disclosure.

One implementation of the process S300 of requesting that the selected temporal relay terminal perform the WLAN temporary relay will be described with reference to FIGS. 1 through 8. The WLAN router may request that the temporal relay terminal perform the WLAN temporal relay (S310), and provide information on the temporal relay terminal to the support target terminals (S320).

As one implementation, in the process S200 of selecting the temporal relay terminal, the relay priority may be calculated depending on at least one of the first and second signal strengths ST1 and ST2.

As another implementation, in the process S200 of selecting the temporal relay terminal, the relay priority may be calculated by multiplying the first signal strength ST1 and the second signal strength ST2 by preset weights, respectively, and then adding them together, as represented by Mathematical Equation 1.

As another implementation, in the process S200 of selecting the temporal relay terminal, the relay priority may be calculated by multiplying the first signal strength ST1, the second signal strength ST2, and the signal strength change amount ΔST per second by preset weights, respectively, and then adding them together, as represented by Mathematical Equation 2.

As set forth above, according to exemplary embodiments of the present disclosure, a WLAN communications area may be automatically expanded by automatically requesting a communications terminal in a WLAN communications-enabled area to perform a WLAN temporary relay with respect to a communications terminal outside of the WLAN communications-enabled area. Therefore, WLAN communications may be possible regardless of a position of the WLAN router.

While exemplary embodiments have been shown and described above, it will be apparent to those skilled in the art that modifications and variations could be made without departing from the spirit and scope of the present disclosure as defined by the appended claims.

What is claimed is:

1. A wireless local area network (WLAN) router comprising:
a controlling unit selecting a temporary relay terminal among good communications terminals and performing controlling to request that the selected temporary relay terminal perform a WLAN temporary relay, in the case in which support target terminals outside of a WLAN good communications area are present;
a WLAN communications unit performing WLAN communications with communications-enabled terminals depending on the controlling of the controlling unit to collect information required for selecting the temporary relay terminal from the communications-enabled terminals and provide the collected information to the controlling unit; and
a local area communications unit requesting that the temporal relay terminal perform the WLAN temporal relay of the support target terminals depending on the controlling of the controlling unit.

2. The WLAN router of claim 1, wherein the controlling unit performs controlling to request that the temporal relay terminal selected from among relay candidate terminals depending on a preset selection reference perform the WLAN temporal relay, for the purpose of the support target terminals, the support target terminals having first signal strengths lower than a first reference strength that is preset to thereby be in a poor communications state, the relay candidate terminals having second signal strengths higher than a second reference strength that is preset to thereby be in a good communications state, the first signal strengths corresponding to signal strengths between the WLAN router and the communications-enabled terminals capable of performing the WLAN communications, and the second signal strengths corresponding to signal strengths between the support target terminals and the communications-enabled terminals.

3. The WLAN router of claim. 2, wherein the controlling unit determines relay priorities as the selection reference depending on a preset priority determining scheme and selects a communications-enabled terminal having the highest priority as the temporary relay terminal.

4. The WLAN router of claim 3, wherein the controlling unit calculates the relay priority based on at least one of the first and second signal strengths.

5. The WLAN router of claim 3, wherein the controlling unit calculates the relay priority by calculating a signal strength change amount per second of the first signal strength, multiplying the first signal strength, the second signal strength, and the signal strength change amount per second by preset weights, respectively, and then adding them together.

6. The WLAN router of claim 2, wherein the controlling unit includes:
a first signal strength collecting unit collecting the first signal strengths between the communications-enabled terminals and the WLAN router;
a support target determining unit determining the support target terminals having the first signal strengths lower than the first reference strength;
a second signal strength collecting unit collecting the second signal strengths between the support target terminals and the communications-enabled terminals;
a relay terminal selecting unit determining that the communications-enabled terminals having the second signal strengths higher than the second reference strength are the relay candidate terminals and selecting the temporal relay terminal among the relay candidate terminals depending on the preset selection reference; and
a relay requesting unit requesting that the temporary relay terminal to perform the WLAN temporal relay.

7. The WLAN router of claim 6, wherein the relay terminal selecting unit determines relay priorities as the selection reference depending on a preset priority determining scheme and selects a communications-enabled terminal having the highest priority as the temporary relay terminal.

8. The WLAN router of claim 7, wherein the relay terminal selecting unit calculates the relay priority based on at least one of the first and second signal strengths.

9. The WLAN router of claim 7, wherein the relay terminal selecting unit calculates the relay priority by calculating a signal strength change amount per second of the first signal strength, multiplying the first signal strength, the second signal strength, and the signal strength change amount per second by preset weights, respectively, and then adding them together.

10. A WLAN router comprising:
a controlling unit performing controlling to request a temporal relay terminal selected from among relay candidate terminals depending on a preset selection reference to perform a WLAN temporal relay, for the purpose of support target terminals, the support target terminals having first signal strengths lower than a first reference strength that is preset, the relay candidate terminals having second signal strengths higher than a second reference strength that is preset, the first signal strengths corresponding to signal strengths between the WLAN router and communications-enabled terminals capable of performing WLAN communications, and the second signal strengths corresponding to signal strengths between the support target terminals and the communications-enabled terminals;
a WLAN communications unit performing the WLAN communications with the communications-enabled terminals depending on the controlling of the controlling unit to collect the first signal strengths and information required for selecting the temporary relay terminal from the communications-enabled terminals and provide the collected first signal strengths and information to the controlling unit; and
a local area communications unit requesting that the temporal relay terminal perform the WLAN temporal relay of the support target terminals depending on the controlling of the controlling unit,
wherein the controlling unit determines relay priorities as the selection reference based on the first and second signal strengths and selects a communications-enabled terminal having the highest priority as the temporary relay terminal.

11. The WLAN router of claim 10, wherein the controlling unit calculates the relay priority by multiplying the first signal strength and the second signal strength by preset weights, respectively, and then adding them together.

12. The WLAN router of claim 10, wherein the controlling unit calculates the relay priority by calculating a signal strength change amount per second of the first signal strength, multiplying the first signal strength, the second signal strength, and the signal strength change amount per second by preset weights, respectively, and then adding them together.

13. A communications method of a WLAN router, comprising:
determining support target terminals having first signal strengths lower than a first reference strength that is preset, the first signal strengths corresponding to signal strengths between the WLAN router and communications-enabled terminals capable of performing WLAN communications;
determining that communications-enabled terminals having second signal strengths higher than a second reference strength that is preset are relay candidate terminals and selecting a temporal relay terminal among the relay candidate terminals depending on a preset selection reference, the second signal strengths corresponding to signal strengths between the support target terminals and the communications-enabled terminals; and
requesting that the selected temporal relay terminal perform a WLAN temporal relay.

14. The communications method of a WLAN router of claim 13, wherein the determining of the support target terminals includes:
collecting the first signal strengths between the communications-enabled terminals and the WLAN router; and
determining the support target terminals having the first signal strengths lower than the first reference strength that is preset.

15. The communications method of a WLAN router of claim 13, wherein the determining of the support target terminals includes:
collecting the first signal strengths between the communications-enabled terminals and the WLAN router and measuring signal strength change values per second of the first signal strengths; and
determining the support target terminals depending on the first signal strengths and the signal strength change values.

16. The communications method of a WLAN router of claim 13, wherein the determining of the support target terminals includes:
collecting the first signal strengths between the communications-enabled terminals and the WLAN router and measuring signal strength change values per second of the first signal strengths;
determining monitoring target terminals depending on the first signal strengths and the signal strength change values; and
determining that communications-enabled terminals having the first signal strengths lower than the first reference strength among the monitoring target terminals are the support target terminals.

17. The communications method of a WLAN router of claim 13, wherein the selecting of the temporal relay terminal includes:
collecting the second signal strengths between the support target terminals and the communications-enabled terminals;
determining that the communications-enabled terminals having the second signal strengths higher than the second reference strength are the relay candidate terminals;
determining the relay priorities with respect to the relay candidate terminals depending on a preset priority determining scheme; and
selecting a relay candidate terminal having the highest priority as the temporal relay terminal.

18. The communications method of a WLAN router of claim 13, wherein the requesting of the selected temporal relay terminal to perform the WLAN temporal relay includes requesting that the temporal relay terminal perform the WLAN temporal relay and providing information on the temporal relay terminal to the support target terminals.

19. The communications method of a WLAN router of claim 13, wherein the selecting of the temporal relay terminal includes calculating the relay priority based on at least one of the first and second signal strengths.

20. The communications method of a WLAN router of claim 13, wherein the selecting of the temporal relay terminal includes calculating the relay priority by multiplying the first signal strength and the second signal strength by preset weights, respectively, and then adding them together.

21. The communications method of a WLAN router of claim 17, wherein the selecting of the temporal relay terminal includes calculating the relay priority by calculating a signal strength change amount per second of the first signal strength, multiplying the first signal strength, the second signal strength, and the signal strength change amount per second by preset weights, respectively, and then adding them together.
